(19) United States
(12) Patent Application Publication
(10) Pub. No.: US 2006/0256219 A1
(43) Pub. Date: Nov. 16, 2006

(54) Photoelectric element and terminal equipment including a photoelectric element

(76) Inventor: Osmo Schroderus, Sumiainen (FI)

Correspondence Address: HARRINGTON & SMITH, LLP, 4 RESEARCH DRIVE, SHELTON, CT, 06484-6212, US

(21) Appl. No.: 10/555,975

(22) PCT Filed: May 13, 2004
(86) PCT No.: PCT/FI04/50061

§ 371 Date: Nov. 7, 2005

(30) Foreign Application Priority Data
May 30, 2003 (FI) 20035076

(51) Int. Cl. H04N 5/335; H04N 3/14

(52) U.S. Cl. 348/307; 348/308; 348/311

(57) ABSTRACT

The invention relates to a photoelectric element (10), which is arranged to visualize digital photoelectric information, in which the said element (10) is formed of several emission-pixel elementary units (R, G, B) arranged vertically and horizontally, which pixel elementary units (R, G, B) are arranged to emit light and the joint effect of which emission-pixel elementary units (R, G, B) being to arrange the said information to be visualized using the element (10). In addition, detection-pixel elementary units (D), which are arranged to essentially simultaneously detect light in order to form digital information from it, are also arranged in the said photoelectric element (10). The invention also relates to terminal equipment using the element.

The present invention relates to a photoelectric element, which is arranged to visualize digital photoelectric information, in which the said element is formed of several emission-pixel elementary units arranged vertically and horizontally, which pixel elementary units are arranged to emit light and the joint effect of which emission-pixel elementary units being to arrange the said information to be visualized using the element. In addition to the above, the invention also relates to terminal equipment including the photoelectric element.

Mobile terminal equipment, equipped with camera devices, which can nowadays be used to record, for example, a still image, a moving image, or even to participate in video-conferencing, is known from the prior art. In the known pieces of terminal equipment, and the display element is generally located on the same side as the keypad, the camera element being located on the other side of the terminal equipment to the display. Such positioning of the elements is indeed highly suitable for, for example, especially still and video imaging, as the view being imaged can then be continuously examined on the display by the user and can thus easily be aimed to suit the current imaging situation.

Some terminal equipment solutions are also known from the prior art, in which camera and display elements, which are essentially separate from each other, are located on the same side of the terminal equipment. Such pieces of terminal equipment permit, for example, visual communication video conferencing, in which the participants in the conference are continuously visible to each other, provided of course that each has terminal equipment with the camera sensor and the display element located on the same side. It is also known that, instead of being fitted permanently to the terminal equipment, the camera element can be also be detachable.

Nevertheless, pieces of terminal equipment of the type described above leave a great deal to be desired in terms of user comfort in visual communications video conferencing. One such factor affecting user comfort detrimentally is the lack of eye contact between participants during a conference. This is due to the fact that, in a conference, the attention of participants is naturally preferably drawn to the display component of the terminal equipment that visualizes another participant, instead of to the detecting camera element that transmits an image to the other participants. Because the camera element capturing image information for the other party is essentially separate from the display component, the participants seem to look past the camera, preventing the creation of eye contact. Conference participants may then be given an unpleasant feeling of the others being ‘absent’ and appearing to avoid eye contact with them. Though the conference participants may be perfectly well aware of the reason for this, it is nevertheless very unpleasant.

The present invention is intended to create a new type of photoelectric element, which is characterized by having a dual function. The characterizing features of the photoelectric element according to the invention are stated in the accompanying claim 1. In addition to the above, the invention is also intended to create terminal equipment using the photoelectric element according to the invention, in which even several different functionalities can be implemented by utilizing the invention. The characterizing features of the terminal equipment according to the invention are stated in the accompanying claim 6.

In general, the invention relates to pieces of terminal equipment equipped with camera elements, digital imaging, and display element technology. The photoelectric element according to the invention includes light-emitting pixel elementary units and light-detecting pixel elementary units arranged in essentially the same component. The pixel elementary units are arranged to operate essentially simultaneously, so that several functionalities can be advantageously permitted in terminal equipment according to the invention.

According to a first embodiment, the detection-pixel elementary units at least partly cover the total area of the photo-electric element. Thus, detection-pixel elementary units can be interlaced in the element among groups of elementary units formed of emission-pixel elementary units, while nevertheless remaining essentially separate from them. A second alternative implementation is, for example, in the case of pieces of terminal equipment with colour displays with elementary-unit groups of emission-pixel elementary units formed to create different colour hues, to arrange detection-pixel elementary units in at least some of these elementary-unit groups.

One advantage achieved with terminal equipment applying photo-electric elements according to the first example of the invention is substantially improved user comfort in two-way video communication. In this case, participants in a videoconference achieve realistic eye contact with each other.

A second example of a functionality of terminal equipment implemented using the photoelectric elements according to the invention, and which is entirely new compared to the prior art, is a digital mirror. Instead of the information detected using the camera element being sent over a data transfer network to receiving terminal equipment, as takes place, for example, in the case of a video-conferencing connection, this information can now be processed in the terminal equipment in such a way that it is shown on the terminal equipment's own display element.

Other features characteristic of the photoelectric element according to the invention and of the terminal equipment using it will be apparent from the accompanying Claims, while additional advantages achieved are itemized in the description portion.

In the following, the photoelectric element according to the invention and the terminal equipment using it, which are not restricted to the embodiments disclosed in the following, are examined in greater detail with reference to the accompanying figures, in which

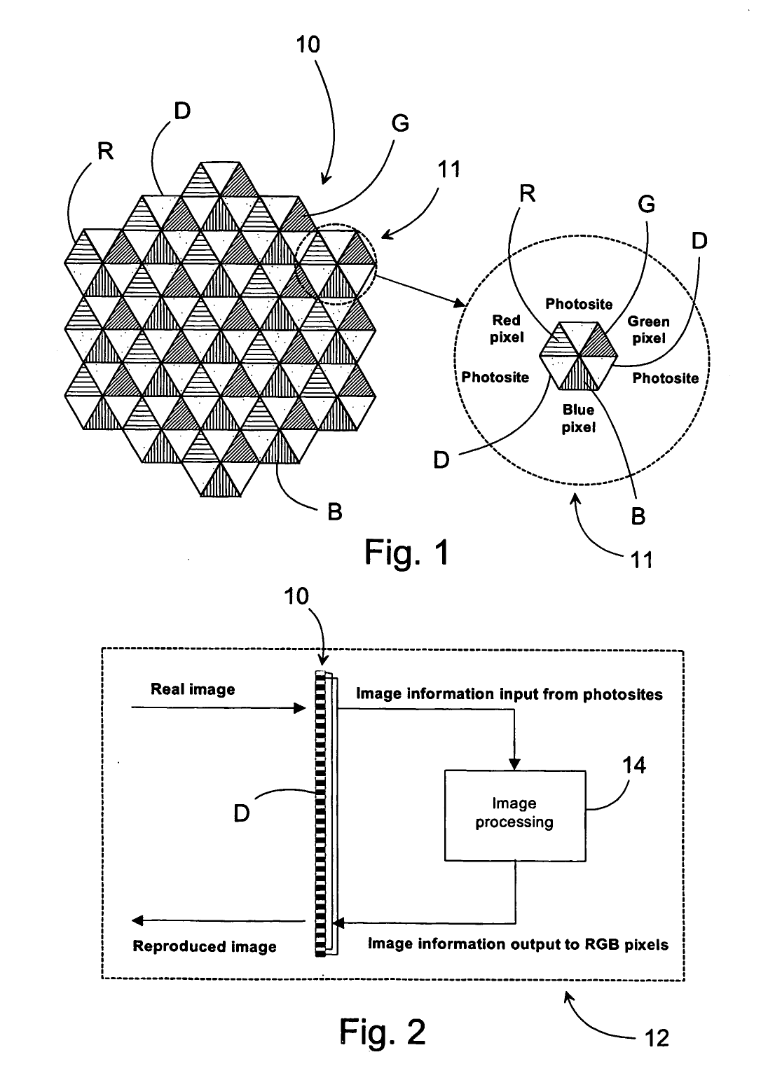

FIG. 1 shows a schematic diagram of the photoelectric element according to the invention,

FIG. 2 shows a schematic diagram of the use of the photoelectric element according to the invention in a first embodiment of the terminal equipment according to the invention,

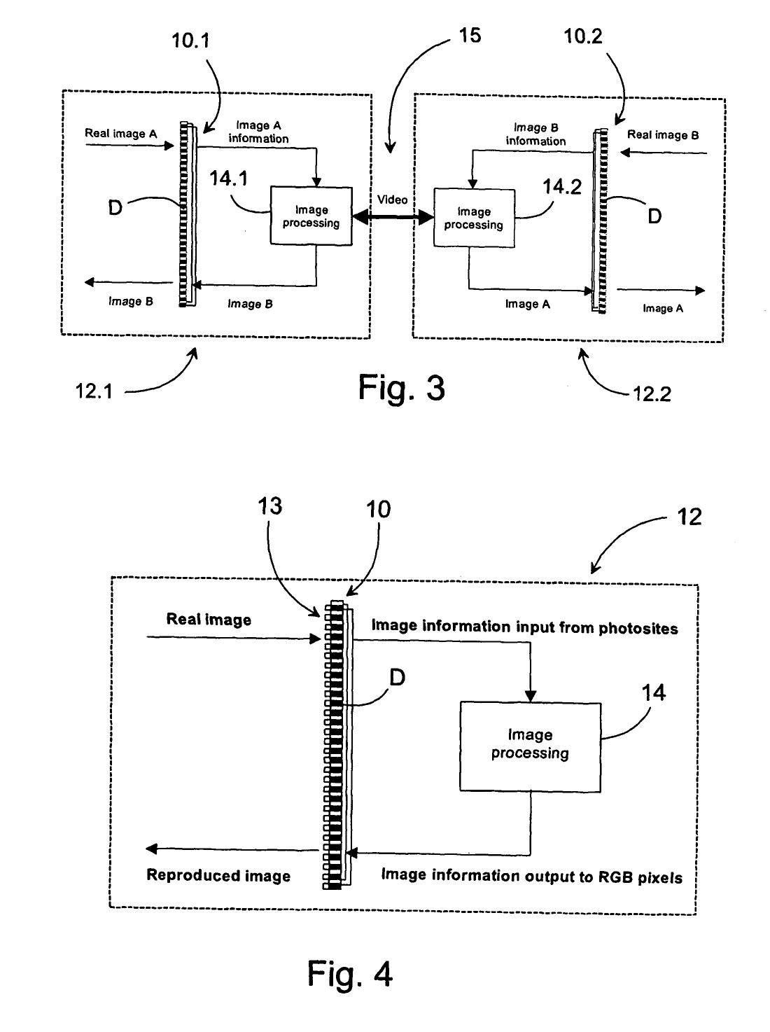

FIG. 3 shows a schematic diagram of the use of the photoelectric element according to the invention in a second embodiment of the terminal equipment according to the invention, and

FIG. 4 shows a schematic diagram of a second embodiment of the photoelectric element according to the invention.

FIG. 1 shows a schematic diagram of the photoelectric element 10 according to the invention. In the photoelectric element 10 according to the invention, display and camera elements are combined in essentially to the same component. The display element 10 can be implemented using, for example, pixel technology that is known as such, in which each of the pixel elementary units R, G, B emits light at the wavelength, or wavelength range set for it. In the display element 10, there can be, for example, such emission-pixel elementary units R, G, B for three wavelength ranges. The wavelength ranges (RGB) creating the colours red, green, and blue can be given as one example of these wavelength ranges.

An elementary-unit group 11, which is formed from pixel elementary units R, G, B, arranged to emit light corresponding to each wavelength range, can be formed in a known manner from the emission pixel elementary units R, G, B. If the elementary-unit groups 11 are arranged sufficiently close together vertically and horizontally in the display element 10, it is possible, according to the known RGB technique, to use combinations of these three primary colours to implement up to a million hues within the scope of the distinguishing capacity of the eye, thus achieving a world of colour that is highly diverse and seemingly authentic.

From the point of view of the user of the terminal equipment 12, the photoelectric element 10 appears to be a conventional display element. However, photosensitive detector-pixel elementary units D, which together form a camera sensor, are also embedded in the element 10. The detection-pixel elementary units D are arranged at preferably regular intervals over the whole area of the photoelectric element 10, so that they are used to cover the area at least partly.

According to a first embodiment, the detection-pixel elementary units D forming the camera sensor can be separate from the emission-pixel elementary units R, G, B or from the elementary-unit groups 11 formed by them. In this case, the density of the emission-pixel elementary units R, G, B forming the display element 10 must maybe, however, be greater, in order to give the user of the terminal equipment a reasonable image quality. In addition, the information produced by the detection-pixel elementary units forming the camera sensor can be suitably interpolated by a program, so that the information thus produced will be understandable to the viewer.

According to a second embodiment, the detection-pixel elementary units D forming the camera sensor can be embedded in the elementary-unit group 11 formed by the emission-pixel elementary units R, G, B forming the display element 10, as shown in the embodiment of FIG. 1.

In the photoelectric element 10 according to the embodiment, in at least some of, and preferably in each of the elementary-unit groups 11 formed by the emission-pixel elementary units R, G, B, there is at least one and preferably several, for example, three photosensitive detection-pixel elementary units D (photosite), which are preferably separate from each other. These detection-pixel elementary units D act as photoelectrical information interceptors that information is in front of the combined camera-display element 10, in other words, they detect the light emitted or reflected from an object in front of the element 10.

The elementary-unit group 11 includes the pixel elementary units R, G, B forming the display element 10, arranged in gaps between these three photosensitive detection-pixel elementary units D, and emitting the primary colours; red, green, and blue. The pixel elementary unit groups 11 can have a polygonal shape, and be, for example, regular hexagons. Each hexagon can then be divided into six equal triangular areas. In the element 10, the elementary-unit groups 11 are set next to each other vertically and horizontally, to that they essentially cover the entire element 10.

Thus, there can either be photosensitive detection-pixel elementary units D, forming the camera sensor 10, in each elementary-unit group 11, or else they can be only in some of the elementary-unit groups 11 of the photoelectric element 10. One example of such an arrangement is detection-pixel elementary units D arranged only in the elementary-unit groups 11 located in the central area of the photoelectric element 10. The number of detection and emission-pixel elementary units D, R, G, B in the photoelectric element 10 and/or in the pixel elementary-unit groups 11, and their location in the photoelectric element 10 are selected in such a way as to achieve the desired image quality in both the visualization and the detection of the information. In terms of the camera function, a relatively large number of pixels is required to obtain an image.

Each group of photoelectric elementary-units can be understood as being dual-functional in a certain sense. The RGB-pixel elementary units R, G, B are used to emit digital image information, for visualization, outwards from the element 10, while the detecting-pixel elementary units D forming the camera sensor 10 receive the light emitted or reflected from the object in front of it.

Besides acting as a traditional display element, the photo-electric element 10 according to the invention can also act as a combined display-camera element 10, in which case it can be used to implement several functionalities.

Next follows a description of possible operating modes, in digital wireless terminal equipment 12, of the photoelectric element 10 according to the invention, which operating modes can be set by the user to be active or passive. According to a first operating mode, the element 10 can operate as a colour display, which is, as such, conventional, with no camera function. The light-detecting pixel elementary groups D forming the photoelectric element 10 will then be passive and the RGB emission pixel elementary units R, G, B will visualize the digital image information using the display 10 of the terminal equipment 12 in a manner that is, as such, known.

FIGS. 2 and 3 show a second and third operating mode in the terminal equipment 12 according to the invention, which is made possible by the photoelectric element 10 according to the invention. In these functions, the element 10 operates essentially simultaneously as both a display and a camera. These operating modes are a mirror function and a ‘digital image window function’.

In the second operating mode, the photoelectric element 10 of the terminal equipment 12 can be arranged to act as a mirror, which depicts whatever view is in front of it at the time. In this case, rays of light are reflected from the object in front of the element 10 and, in a known manner, travel to the photoelectric element 10 according to the invention. Both types of pixel elementary units, i.e. the light-detecting pixel elementary units D and the light-emitting pixels R, G, B, are now active in the element 10. The light-detecting pixels D capture the light reflected or emitted from the object being imaged to the element 10 and detect it in a manner that is, as such, known. The image-processing functionality 14 of the terminal equipment 12 is used to edit, in a manner that is, as such, known, the light terminating at the pixel elementary units D. The signal processing 14 digitalizes the image information, which is then forwarded to the emission-pixel elementary units R, G, B of the element 10, to be visualized for the user. Emitted colours that escape can also be taken into account electronically when the image is formed.

In the image-processing functionality 14 of the terminal equipment 12, digital image information, which can be shown on the display of the terminal equipment 12, i.e. in this case using the emitting RGB pixels of the photoelectric element 10, is formed from the light captured by the photosensitive detection pixels D. The user of the terminal equipment 12 will then see, on the display, the view in front of the display 10, essentially in real time. However, small delays may appear in showing the view, depending, for example, on the operating speeds of the terminal equipment's 12 signal processing 14, or of the photoelectric element 10.

According to yet a third operating mode, the photoelectric element 10 can be used to implement a video-conferencing link, i.e. a so-called ‘digital window’ between pieces of terminal equipment 12.1, 12.2. In this case, two pieces of terminal equipment 12.1, 12.2, both of which advantageously include a photoelectric element 10.1, 10.2 according to the invention, operate initially in a manner corresponding to that described above in the mirror mode. The image-processing functionalities 14.1, 14.2 of both pieces of terminal equipment 12.1, 12.2 process the light captured from in front of the combined camera-display element 10.1, 10.2, which is emitted or reflected from an object in front of the element 10.1, 10.2. In this case, instead of the digitalized image information being returned for visualization to the combined camera-display element 10.1, 10.2 of the terminal equipment 12.1 that produced it, it is sent over a data network 15 to the other terminal equipment 12.2. The data-transfer method used can be one that is, as such, known, or else a technology that is still under development.

The terminal equipment 12.2 receiving the image information uses its image-processing functionality 14.2 to process the data that its receives and to form from it image information to be visualized in the RGB areas of the pixels of the camera-display element 10.2, which is then shown in the combined camera-display element 10.2 to the user of the terminal equipment 12.2.

A videophone link implemented using the photoelectric element 10 according to the invention achieves a particular advantage, for example, in terms of the comfort of using the link, because the parties that are connected are now in real eye contact with each other.

FIG. 4 shows a schematic diagram of a second, more highly developed embodiment of the photoelectric element 10 according to the invention. As is known, in camera-sensor implementations, the detecting pixels are generally in a quite small area, for example, an area 5-7-mm square. Thus, the detection-pixel elementary units D in the embodiment described above are distributed over a relatively wide area on the element 10. Such an arrangement may require a system of lenses 13 arranged at least in front of the detection pixel elementary units D forming the camera sensor. The system 13 can be implemented, for example, as an arrangement of micro-lenses, so that it will not interfere with the information being sent/shown. On the other hand, the lens system 13 can also cover the entire photoelectric element 10. In that case, the fuzziness that may arise in the display component can be corrected using the image-processing functionality 14. In addition, the detection-pixel elementary units D can be set sufficiently deeper than the emission pixel elementary units R, G, B to prevent the lens system from interfering with the image being viewed.

The lens system 13 is used to focus the light emitted or reflected from the imaged object to each pixel elementary unit D. Thus, the detection elementary units D receive information along some beam, collecting it from a set area and then focussing it on a single pixel D.

The above is a description of only one example of an embodiment of the photoelectric element 10 according to the invention and of the terminal equipment 12 using it. It should be noted that the terminal equipment can also include, besides the photoelectric element according to the invention, a separate camera sensor of a type that is, as such, known, located on the opposite side of the terminal equipment to the display component, by means of which, for example, still imaging requiring view-finding can be carried out.

It will be obvious to one versed in the art that the technical implementation of the element 10 and the terminal equipment 12 can deviate even greatly from that disclosed above, so that the embodiment disclosed should thus in no way be interpreted as being restrictive. The manufacturing technology for creating a combined display-camera element 10 according to the invention can be chosen from any suitable existing technology, for example, manufacturing technologies for CCD or CMOS cells, or generally from some lithographic method, or some method that is still only being developed. The essential feature in the photoelectric element 10 according to the invention is that the display component and the camera sensor are integrated in essentially the same component 10, which has a level of spatial operation that is, to the extent permitted by manufacturing technology methods, more or less uniform, and in which information is transferred essentially simultaneously in opposite directions, i.e. emitted outwards from the display element and detected from the outside to the camera sensor.

It must be understood that the above description and the related figures are only intended to illustrate the photoelectric element and the terminal equipment using it, according to the present invention. The invention is thus in no way restricted to only the embodiments disclosed or stated in the claims, but many different variations and adaptations of the invention, which are possible within the scope on the inventive idea defined in the accompanying claims, will be obvious to one versed in the art.

1. A photoelectric element, which is arranged to visualize digital photoelectric information, in which the said element is formed of several emission-pixel elementary units arranged vertically and horizontally, which said emission-pixel elementary units are arranged to form elementary-unit groups, which include at least three emission-pixel elementary units and each of which emission-pixel elementary units is arranged to emit light at least in a preset one wavelength or wavelength range and the joint-effect of which emission-pixel elementary units being to arrange the said information to be visualized using the element, and detection-pixel elementary units, which are arranged to essentially simultaneously detect light in order to form digital information from it, are also arranged in the said photoelectric element, characterized in that at least some of the said elementary-unit groups are arranged to include not only emission-pixel elementary units, but also at least one detection-pixel elementary unit.

2. A photoelectric element according to claim 1, characterized in that the said elementary-unit group is arranged as a polygon, preferably a hexagon, and which is divided among the said pixel elementary units in such a way that it includes emission-pixel elementary units arranged separately from each other, and three detection-pixel elementary units arranged between them.

3. A photoelectric element according to claim 1, characterized in that lens means for focussing light to a detection-pixel elementary unit are arranged in the said photoelectric element.

4. A photoelectric element according to claim 3, characterized in that the lens means are arranged to cover at least the detection-pixel elementary units.

5. Terminal equipment, which includes as elements a photoelectric element and a photosensitive element including detection-pixel elementary units for detecting information, as well as means for processing the information handled by the elements, and in which the photoelectric element, is arranged to visualize digital photoelectric information, in which the said element is formed of several emission-pixel elementary units arranged vertically and horizontally, which said emission-pixel elementary units are arranged to form elementary-unit groups, which include at least three emission-pixel elementary units and each of which emission-pixel elementary units is arranged to emit light at least in a preset one wavelength or wavelength range and the joint effect of which emission-pixel elementary units being to arrange the said information to be visualized using the element, and in which the said elements are arranged in connection with essentially the same component and are arranged to operate essentially simultaneously, by using the said means, characterized in that at least some of the said elementary-unit groups are arranged to include not only emission-pixel elementary units, but also at least one detection-pixel elementary unit.

6. Terminal equipment according to claim 5, characterized in that the said means for processing information are arranged to operate in such a way that the information detected by the photosensitive element of the terminal equipment is arranged to be visualized in the photoelectric element of the terminal equipment.

7. Terminal equipment according to claim 6, characterized in that the said means for processing information are arranged to operate in such a way that the information detected by the photosensitive element of one piece of terminal equipment is arranged to be sent to another piece of terminal equipment connected to a data network, by means of the photo-electric element of which it is arranged to be visualized.
